(19) United States
(12) Patent Application Publication
(10) Pub. No.: US 2025/0068435 A1
(43) Pub. Date: Feb. 27, 2025

(54) METHOD FOR MANAGING THE DESIRED STATES OF SOFTWARE-DEFINED DATA CENTERS

(71) Applicant: VMWARE, INC., Palo Alto, CA (US)

(72) Inventors: Nidhin URMESE, Bangalore (IN); Jeffrey Gabriel HU, Palo Alto, CA (US); Bing WU, McLean, VA (US); Anmol KULKARNI, Banalore (IN); Kiyoshi James KOMATSU, San Mateo, CA (US); Lipsa NAYAK, Bangalore (IN)

(21) Appl. No.: 18/381,197

(22) Filed: Oct. 18, 2023

(30) Foreign Application Priority Data
Aug. 24, 2023 (IN) 202341056790

(51) Int. Cl. G06F 9/445

(52) U.S. Cl. CPC G06F 9/44505

(57) ABSTRACT

A method of managing desired states of software-defined data centers (SDDCs), includes the steps of: in response to a user selection of a first modular template that includes a first set of desired configurations and a user selection of a second modular template that includes a second set of desired configurations, creating a composite template that includes desired configurations from the first and second modular templates; and in response to a user selection to assign the composite template to an SDDC, creating a desired state document that includes desired configurations from the composite template and then transmitting an instruction to update actual configurations of the SDDC to match corresponding desired configurations from the desired state document.

### RELATED APPLICATION

Benefit is claimed under 35 U.S.C. 119 (a)-(d) to Foreign application Ser. No. 20/234,1056790 filed in India entitled “METHOD FOR MANAGING THE DESIRED STATES OF SOFTWARE-DEFINED DATA CENTERS”, on Aug. 24, 2023 by VMware, Inc., which is herein incorporated in its entirety by reference for all purposes.

### BACKGROUND

In a software-defined data center (SDDC), virtual infrastructure (VI), which includes virtual machines (VMs) and virtualized storage and networking resources, is provisioned from hardware infrastructure. The hardware infrastructure includes a plurality of host computers, referred to herein simply as “hosts,” and includes storage and networking devices. The provisioning of the VI is carried out by SDDC management software that is deployed on management appliances such as a VMware vCenter Server® appliance and a VMware NSX® appliance, available from VMware, Inc. The SDDC management software manages the VI by communicating with virtualization software (e.g., hypervisors) installed in the hosts.

It has become common to deploy multiple SDDCs across multiple clusters of hosts. Each cluster is a group of hosts that are managed together by SDDC management software to provide cluster-level functions. For example, the functions include load balancing across the cluster through VM migration between the hosts, distributed power management, dynamic VM placement according to affinity and anti-affinity rules, and high availability (HA). The SDDC management software also manages shared storage devices from which storage resources for the clusters are provisioned. The SDDC management software also manages software-defined networks through which the VMs communicate.

Today, many organizations have SDDCs deployed across different geographical regions and even in a hybrid manner. A hybrid deployment includes applications running in a combination of different environments, e.g., on-premise, in a private cloud, in a public cloud, and as a service. SDDCs that are deployed on-premise are provisioned in a particular organization's own information technology (IT) environment. SDDCs that are deployed in a private cloud are provisioned in a private data center controlled by the organization. SDDCs that are deployed in a public cloud are provisioned in a public data center at which SDDCs of other organizations are also provisioned. SDDCs that are deployed as a service are provided to the organization on a subscription basis such that management operations such as configuring, upgrading, and patching are performed for the organization according to a service-level agreement (SLA).

With increasing numbers of SDDCs, monitoring and performing operations on SDDCs and managing the lifecycle of management software therein have proven to be challenging. Conventional techniques include defining the desired state of each SDDC in a declarative document, the desired state including desired configurations for services running in management appliances of the SDDC. The SDDCs are deployed and periodically updated according to desired states defined in respective desired state documents. For a variety of reasons, such techniques are not practicable when there is a large number of SDDCs, especially when they are spread out across multiple geographical locations and deployed in a hybrid manner.

Firstly, despite there being overlap in the configurations of different SDDCs, administrators of organizations invest great time, effort, and money creating desired state documents for each SDDC. Secondly, for an organization to modify configurations throughout its SDDCs, the organization must update several desired state documents, which is difficult to manage (i.e., unscalable) with increasing numbers of SDDCs. That difficulty in management has a variety of negative effects. For example, updating increasing numbers of desired state documents is error-prone and unreliable, resulting in desired state documents becoming inconsistent even for configurations that are intended to overlap. As another example, it is difficult to ensure that all the desired state documents conform to best practices and industry guidelines. A simpler and more scalable method for managing desired states of SDDCs is desired.

### SUMMARY

One or more embodiments provide a method of managing desired states of SDDCs. The method includes the steps of: in response to a user selection of a first modular template that includes a first set of desired configurations and a user selection of a second modular template that includes a second set of desired configurations, creating a composite template that includes desired configurations from the first and second modular templates; and in response to a user selection to assign the composite template to an SDDC, creating a desired state document that includes desired configurations from the composite template and then transmitting an instruction to update actual configurations of the SDDC to match corresponding desired configurations from the desired state document.

Further embodiments include a non-transitory computer-readable storage medium comprising instructions that cause a computer system to carry out the above method, as well as a host configured to carry out the above method.

### BRIEF DESCRIPTION OF THE DRAWINGS

FIG. 1 is a block diagram of customer environments of different organizations that are managed through a multi-tenant cloud platform implemented in a public cloud.

FIG. 2 is a block diagram of the public cloud and an SDDC of one of the customer environments, according to embodiments.

FIG. 3 is a block diagram of services of a VM management appliance of the SDDC, according to embodiments.

FIGS. 4A-4F are block diagrams illustrating examples of user interfaces (UIs) for creating and assigning a desired state document, according to embodiments.

FIG. 5 is a flow diagram of a method performed by a configuration service of the public cloud to create a desired state document, according to an embodiment.

FIG. 6 is a flow diagram of a method performed by the configuration service to add, modify, and remove desired configurations for the desired state document, according to an embodiment.

FIG. 7 is a flow diagram of a method performed by the configuration service, a configuration agent of the customer environment, and management appliances of a plurality of SDDCs to apply desired configurations from a desired state document, according to an embodiment.

FIG. 8 is a flow diagram of a method performed by the configuration service to update a desired state document for retransmitting to one or more SDDCs or clusters, according to an embodiment.

### DETAILED DESCRIPTION

Techniques for managing desired state documents of SDDCs are described. According to embodiments, a cloud platform delivers various services to the SDDCs through agents that are running in an appliance. The services of the cloud platform are referred to herein as “cloud services,” and the appliance in which the agents are running is referred to as an “agent platform (AP) appliance.” The cloud platform is provisioned in a public cloud, and the AP appliance is deployed in a customer environment along with management appliances.

Each of the cloud services has a corresponding agent on the AP appliance that the cloud service communicates with, the cloud platform and AP appliance being connected over a public network such as the Internet. Furthermore, the AP appliance and management appliances are connected to each other over a private network of the customer environment such as a local area network (LAN). Accordingly, the cloud services and management appliances are able to communicate through the agents of the AP appliance. Through such communication, a cloud service referred to herein as a “configuration service” manages the desired states of SDDCs.

Via a user interface (UI) of the configuration service, an organization creates “modular templates,” “composite templates,” and desired state documents. Modular templates are collections of desired configurations that are logically grouped together. For example, storage configurations for SDDCs of one geographic region are grouped into one modular template, and storage configurations for SDDCs of another geographic region are grouped into another modular template. Composite templates are collections of modular templates that are logically grouped together. For example, storage and network modular templates for one geographic region are grouped together in a composite template. Desired state documents are collections of modular and composite templates that are assigned to entities such as SDDCs and clusters.

After creating a desired state document, the organization identifies one or more SDDCs or clusters to apply the desired state document to. The desired state document is then downloaded to the organization's customer environment and applied to the identified SDDCs or clusters by management appliances. Specifically, if not already deployed, the management appliances deploy the SDDCs or clusters according to desired configurations of the desired state documents. Otherwise, if already deployed, the management appliances update actual configurations of the SDDCs or clusters to match the desired configurations of the desired state documents.

By using modular templates, the techniques herein allow for reusing desired configurations that overlap between desired state documents, which saves administrators of the organization time, effort, and money. Additionally, such usage of modular templates is highly scalable. For example, if an organization modifies desired configurations of a single modular template, those modifications are automatically inherited by composite templates and desired state documents that include the modular template. Such reusability and case of updating increase consistency for desired configurations that are intended to overlap and help ensure that a large number of desired state documents conform to best practices and industry guidelines. These and further aspects of the invention are discussed below with respect to the drawings.

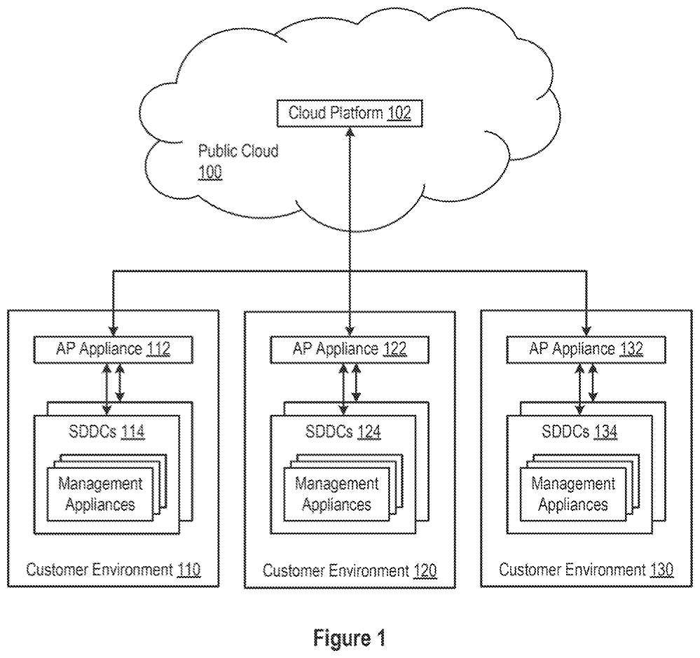

FIG. 1 is a block diagram of customer environments 110, 120, and 130 of different organizations (customers). The customer environments are managed through a multi-tenant cloud platform 102 implemented in a public cloud 100. A plurality of SDDCs is illustrated in each of the customer environments, including SDDCs 114 in customer environment 110. SDDCs 124 in customer environment 120, and SDDCs 134 in customer environment 130. As used herein, a “customer environment” means one or more on-premise IT environments managed by the organization, a private cloud managed by the organization, a public cloud managed for the organization by another organization, or any combination of these.

In each customer environment, the SDDCs are managed by respective management appliances. The management appliances of each of the customer environments include a VM management appliance (e.g., a VMware vCenter Server® appliance, available from VMware, Inc.) for overall management of VI. The management appliances of each of the customer environments further include a network management appliance (e.g., a VMware NSX® appliance, available from VMware, Inc.) for management of virtual networks.

The management appliances in each of the customer environments communicate with a respective AP appliance, including an AP appliance 112 in customer environment 110, an AP appliance 122 in customer environment 120, and an AP appliance 132 in customer environment 130. Agents (not shown in FIG. 1) are installed on each of the AP appliances, and the agents communicate with cloud platform 102 to deliver cloud services to respective customer environments. In some embodiments, each of the AP appliances and each of the management appliances are a VM instantiated on a host. In other embodiments, any of the AP appliances and the management appliances are implemented as hosts.

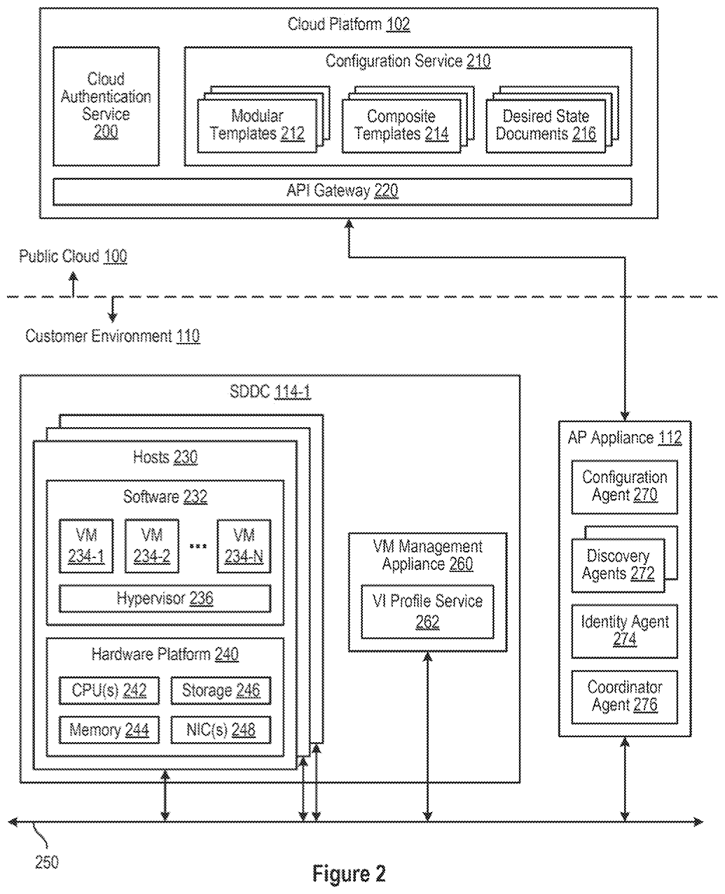

FIG. 2 is a block diagram of public cloud 100 and customer environment 110, according to embodiments. Customer environment 110 includes an SDDC 114-1, which includes a plurality of hosts 230 and a VM management appliance 260. Each of hosts 230 is constructed on a hardware platform 240 such as an x86 architecture platform. Hardware platform 240 includes conventional components of a computing device, such as one or more central processing units (CPUs) 242, memory 244 such as random-access memory (RAM), storage 246 such as one or more magnetic drives or solid-state drives (SSDs) and/or a host bus adapter for connecting to a storage area network, and one or more network interface cards (NICs) 248. NIC(s) 248 enable hosts 230 to communicate with each other and with other devices over a network 250.

Network 250 is distinguishable from a public network such as the Internet through which cloud platform 102 communicates with devices of customer environment 110. Network 250 is a private network, e.g., a LAN or a sub-net, and is partitioned from the public network through a firewall. Hardware platform 240 of each of hosts 230 supports software 232. Software 232 includes a hypervisor 236, which is a virtualization software layer. Hypervisor 236 supports a VM execution space within which VMs 234 are concurrently instantiated and executed. One example of hypervisor 236 is a VMware ESX® hypervisor, available from VMware, Inc.

VM management appliance 260 logically groups hosts 230 into one or more clusters to perform cluster-level tasks such as provisioning and managing VMs 234 and migrating VMs 234 from one of hosts 230 to another. VM management appliance 260 communicates with hosts 230 via a management logical network (not shown) provisioned from network 250. In embodiments described herein, VM management appliance 260 is one of VMs 234 or one of hosts 230. However, in other embodiments, VM management appliance 260 is implemented via virtual computing instances besides VMs such as containers, Docker® containers, data compute nodes, and isolated user space instances.

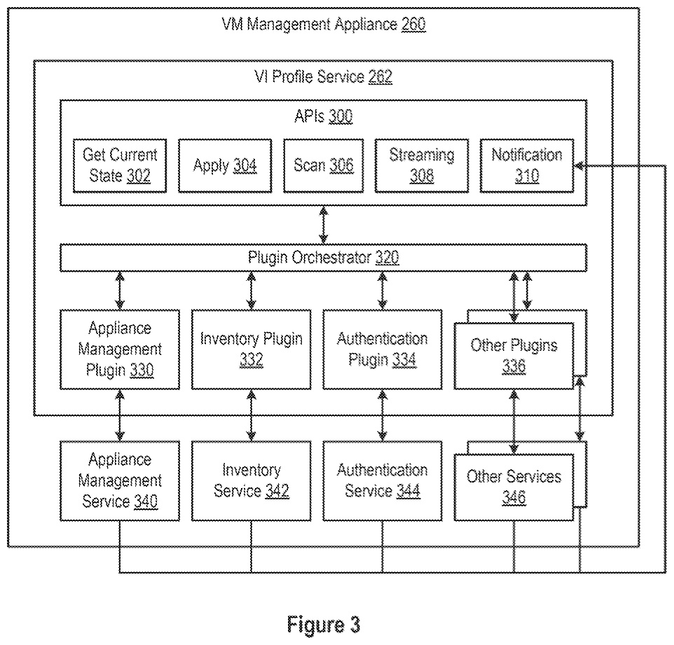

VM management appliance 260 includes a VI profile service 262 and various other services (not shown in FIG. 2). VI profile service 262 provides various functionalities for managing the desired state of SDDC 114-1 and clusters therein such as getting the current state of SDDC 114-1 and applying a desired state document. VM management appliance 260 issues role-based authentication tokens such as Security Assertions Markup Language (SAML) tokens. Each authentication token allows a party possessing the token to access VM management appliance 260 to perform operations that are associated with the issued token. VM management appliance 260 is discussed further below in conjunction with FIG. 3.

Public cloud 100 is operated by a cloud computing service provider from a plurality of hosts (not shown). CPU(s) of the hosts are configured to execute instructions such as executable instructions that perform one or more operations described herein, which may be stored in memory of the hosts. Cloud platform 102 includes a cloud authentication service 200, a configuration service 210, and other cloud services (not shown). Such other cloud services include an upgrade service, a monitoring service, etc. In one embodiment, each of the cloud services of cloud platform 102 is a microservice that is implemented as one or more container images executed on VI of public cloud 100. Devices of customer environment 110 communicate with the cloud services by making application programming interface (API) calls such as Java API calls to an API gateway 220.

Cloud authentication service 200 enables authentication with configuration service 210 and the other cloud services. To enable such authentication, cloud authentication service 200 issues access tokens such as JavaScript Object Notation (JSON) web tokens (JWTs). Each access token allows a requesting party to communicate with a cloud service via API gateway 220. It should be noted that although cloud authentication service 200 is illustrated as being within cloud platform 102, cloud authentication service 200 may run on a virtual or physical computer that is outside of cloud platform 102 but accessible thereto.

Configuration service 210 manages desired states of SDDCs and clusters for the organization of customer environment 110. Configuration service 210 stores modular templates 212, composite templates 214, and desired state documents 216. Modular templates are collections of desired configurations grouped logically together logically. Composite templates are collections of modular templates that are logically grouped together. Desired state documents are collections of modular and composite templates that are assigned to entities such as SDDCs and clusters.

AP appliance 112 includes a configuration agent 270, discovery agents 272, an identity agent 274, and a coordinator agent 276. Identity agent 274 acquires access tokens from cloud authentication service 200 for other agents of AP appliance 112. Accordingly, identity agent 274 contains a client ID and client secret (not shown), which identity agent 274 includes in requests to cloud authentication service 200 for access tokens. Configuration agent 270 acquires access tokens from identity agent 274 to authenticate with configuration service 210, e.g., to download one of desired state documents 216 to be applied to SDDC 114-1 or to one or more clusters thereof.

Discovery agents 272 manage communications with respective management appliances. For example, one of discovery agents 272 manages communications with VM management appliances for all SDDCs 114. To manage such communications, discovery agents 272 store administrative credentials for logging in to respective management appliances and acquiring authentication tokens therefrom for other agents of AP appliance 112. To communicate with VM management appliances, configuration agent 270 acquires authentication tokens from one of discovery agents 272. Configuration agent 270 then uses the authentication tokens to invoke various APIs of VI profile services to manage the desired states of SDDCs and clusters.

Coordinator agent 276 installs the other agents of AP appliance 112 and manages the lifecycles thereof. In embodiments described herein, AP appliance 112 is one of VMs 234 or one of hosts 230. However, in other embodiments, AP appliance 112 is implemented via other types of virtual computing instances besides VMs such as containers, Docker® containers, data compute nodes, and isolated user space instances.

FIG. 3 is a block diagram of services of VM management appliance 260, according to embodiments. In addition to VI profile service 262, VM management appliance 260 includes an appliance management service 340, an inventory service 342, an authentication service 344, and various other services 346. Appliance management service 340 provides system-level functionalities for VM management appliance 260 such as secure shell (SSH), network time protocol (NTP), resource utilization monitoring, network configuration, patching, and updating. Inventory service 342 creates and manages inventory items of SDDC 114-1 such as virtual compute, storage, and networking resources. Authentication service 344 performs role-based access to VMs 234.

Services 340-346 have corresponding plugins to VI profile service 262, including an appliance management plugin 330, an inventory plugin 332, an authentication plugin 334, and various other plugins 336. The plugins are registered with VI profile service 262 when VI profile service 262 is launched. VI profile service 262 manages actual configurations of services 340-346 based on a desired state document for SDDC 114-1 or for clusters therein. The desired state document includes desired configurations for the services, desired configurations being made up of attributes and associated values.

VI profile service 262 exposes various APIs that are invoked by configuration agent 270 and by services 340-346. The APIs include a get-current-state API 302, an apply API 304, a scan API 306, a streaming API 308, and a notification API 310. Get-current-state API 302 is invoked by configuration agent 270 to obtain the current state (actual configurations) of SDDC 114-1 or of clusters therein. Apply API 304 is invoked by configuration agent 270 to apply desired configurations of a desired state document. Scan API 306 is invoked by configuration agent 270 to compute drift in the current state of SDDC 114-1 or of clusters therein from configurations of a desired state. Streaming API 308 is invoked by configuration agent 270 to obtain streaming updates, including for drift detection. Notification API 310 is invoked by services 340-346 to alert VI profile service 262 of changes to actual configurations.

VI profile service 262 includes a plugin orchestrator 320 through which configuration agent 270 communicates with plugins 330-336 via APIs 300. Configuration agent 270 communicates with plugin orchestrator 320, e.g., to obtain, via get-current-state API 302, the current state of SDDC 114-1 or of clusters therein. Plugin orchestrator 320 then communicates with plugins 330-336 to obtain respective portions of the current state. Similarly, configuration agent 270 communicates with plugin orchestrator 320 to apply, via apply API 304, a desired state document, and plugin orchestrator 320 communicates respective portions of the desired state to plugins 330-336.

To configure settings of VM management appliance 260 such as enabling or disabling SSH, plugin orchestrator 320 provides desired configurations to appliance management plugin 330 to be applied to appliance management service 340. To configure the inventory of SDDC 114-1 or of clusters therein such as by specifying an amount of virtual compute resources, plugin orchestrator 320 provides desired configurations to inventory plugin 332 to be applied to inventory service 342. To configure authentication privileges of SDDC 114-1 or of clusters therein such as by creating a new role for performing operations on one or more of hosts 230, plugin orchestrator 320 provides desired configurations to authentication plugin 334 to be applied to authentication service 344. For desired configurations related to other services 346, plugin orchestrator 320 provides the desired configurations to one of other plugins 336 to be applied to a corresponding one of other services 346.

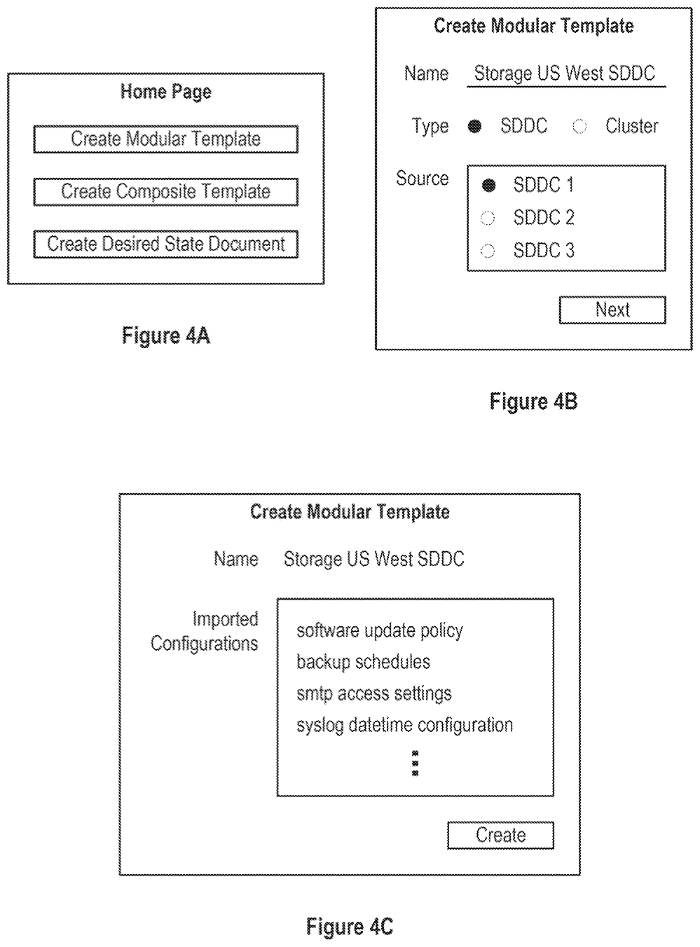

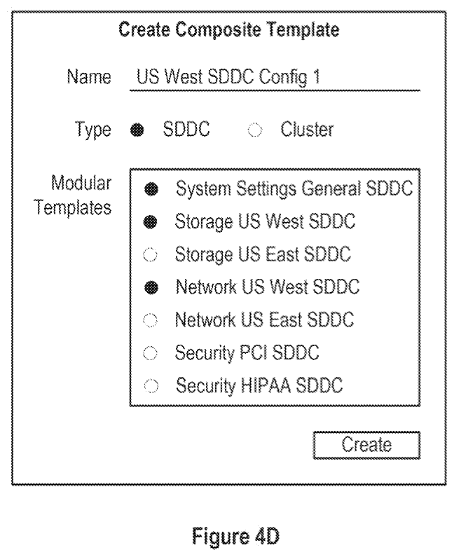

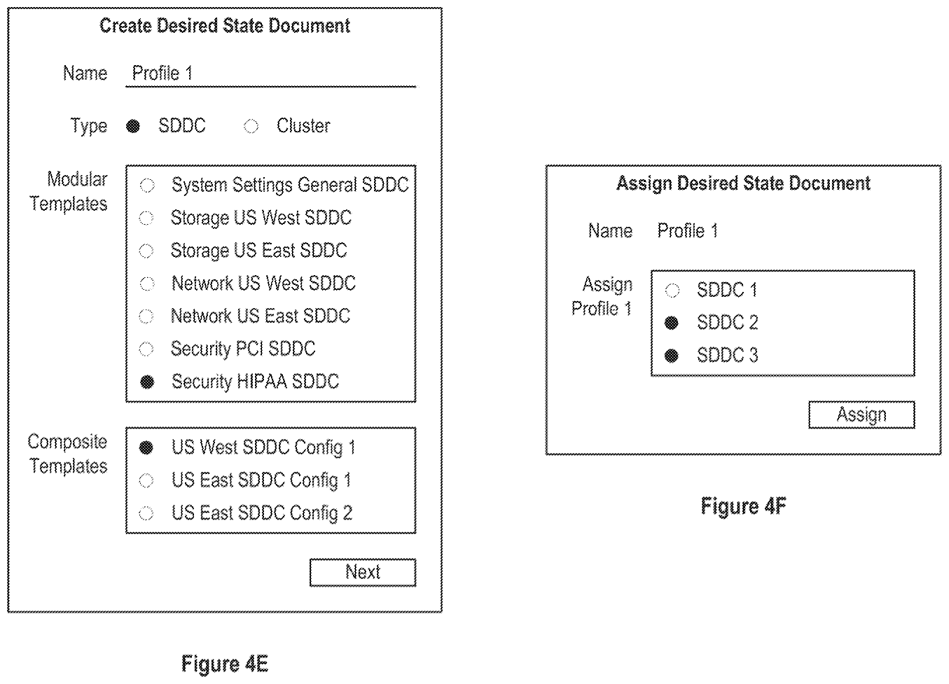

FIGS. 4A-4F are block diagrams illustrating examples of user interfaces (UIs) for creating and assigning a desired state document, according to embodiments. The UIs are hosted by configuration service 210 and accessed by administrators of the organization, e.g., via the Internet. FIG. 4A illustrates a UI for a home page at which an administrator is presented with three options: (1) to create a modular template, (2) to create a composite template from a plurality of modular templates, or (3) to create a desired state document from composite and modular templates. Clicking “Create Modular Template” leads the administrator to the UIs of FIGS. 4B and 4C, clicking “Create Composite Template” leads to the UI of FIG. 4D, and clicking “Create Desired State Document” leads to the UIs of FIGS. 4E and 4F.

FIG. 4B illustrates a UI for creating a modular template. As illustrated, the administrator has entered to name the modular template “Storage US West SDDC” to designate the modular template as storing storage configurations for an SDDC located on the west coast of the United States. The administrator has also designated the modular template as being for SDDCs. The administrator has also specified to import actual configurations from an SDDC called “SDDC 1” that has already been configured. Once the administrator clicks “Next,” configuration service 210 displays the UI of FIG. 4C.

FIG. 4C illustrates a UI with actual configurations that have been imported for Storage US West SDDC. As illustrated, there are imported configurations for a “software update policy,” “backup schedules,” “smtp access settings,” and a “syslog datetime configuration.” The administrator may interact with the illustrated list to modify imported configurations or to add or remove configurations. For example, the administrator may choose to only include storage-related configurations from the illustrated list.

When the administrator clicks “Create,” a modular template is created from any selected configurations. It should be noted that an administrator may designate desired configurations for a modular template in different ways than that illustrated in FIGS. 4B-4C. For example, the administrator may import configurations from elsewhere besides from an SDDC. The administrator may even create all the desired configurations manually.

FIG. 4D illustrates a UI for creating a composite template. As illustrated, the administrator has entered to name the composite template “US West SDDC Config 1” to designate the composite template as storing desired configurations for an SDDC located on the west coast of the United States. The administrator has also designated the composite template as being for SDDCs. The administrator has also specified to include in the composite template, desired configurations from three modular templates: “System Settings General SDDC,” “Storage US West SDDC,” and “Network US West SDDC.”

System Settings General SDDC stores general configurations that are applicable to a variety of SDDCs. Storage US West SDDC and Network US West SDDC store storage and network configurations, respectively, for SDDCs on the west coast of the United States. When the administrator clicks “Create,” a composite template is template is created from the selected modular templates. Although not shown in FIG. 4D, the administrator may also further customize the composite template by modifying, adding desired configurations to, or removing desired configurations from the desired configurations that would otherwise be added from the selected modular templates.

FIG. 4E illustrates a UI for creating a desired state document. As illustrated, the administrator has entered to name the desired state document “Profile 1.” The administrator has also designated the desired state document as being for SDDCs. The administrator has also specified to include desired configurations from two templates in the desired state document: a modular template named “Security HIPAA SDDC” and a composite template named “US West SDDC Config 1.”

Security HIPAA SDDC stores network configurations based on the Health Insurance Portability and Accountability Act (HIPAA), and US West SDDC Config 1 stores desired configurations for an SDDC located on the west coast of the United States. Once the administrator clicks “Next,” configuration service 210 displays the UI of FIG. 4F. Although not illustrated in FIG. 4E, the administrator may also further customize the desired state document by modifying, adding desired configurations to, or removing desired configurations from the desired configurations that would otherwise be added from the selected templates.

FIG. 4F illustrates a UI for assigning a desired state document. In the example of FIG. 4F, the administrator is assigning Profile 1 to two SDDCs: an “SDDC 2” and an “SDDC 3.” Once the administrator clicks “Assign,” configuration service 210 transmits the desired state document to a customer environment to be applied to SDDC 2 and SDDC 3. SDDCs 2 and 3 are then deployed (or updated if already deployed) according to desired configurations defined in Profile 1.

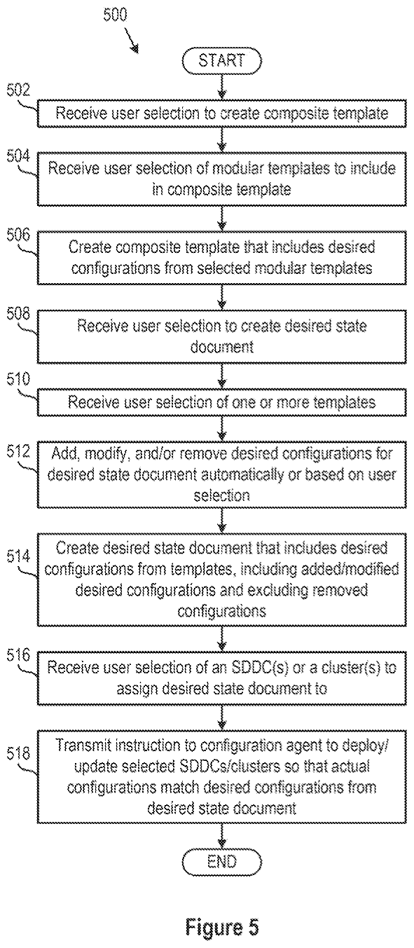

FIG. 5 is a flow diagram of a method 500 performed by configuration service 210 to create a desired state document, according to an embodiment. Method 500 is discussed with respect to customer environment 110 but may be performed with respect to any customer environment. Method 500 is performed after administrators of the organization have already created a plurality of modular templates. At step 502, configuration service 210 receives a user selection to create a composite template. For example, an administrator may click a “Create Composite Template” button, as illustrated in FIG. 4A.

At step 504, configuration service 210 receives a user selection of modular templates to include in the composite template. For example, the administrator may select radio buttons corresponding to the modular templates, as illustrated in FIG. 4D. At step 506, configuration service 210 creates a composite template that includes desired configurations from the selected modular templates. At step 508, configuration service 210 receives a user selection to create a desired state document. For example, the administrator may click a “Create Desired State Document” button, as illustrated in FIG. 4A.

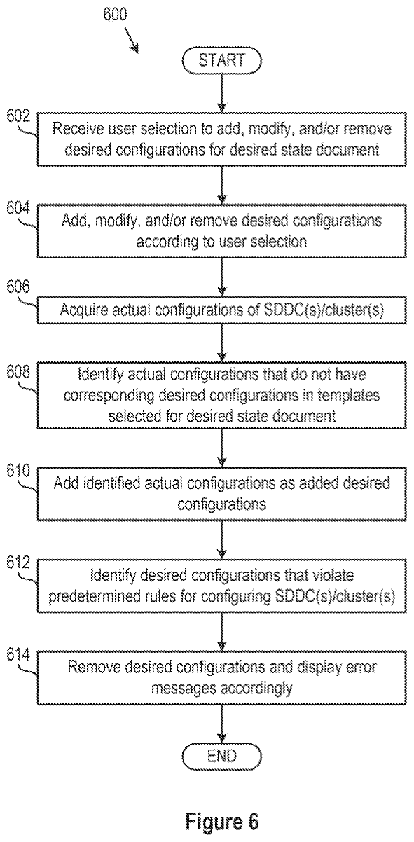

At step 510, configuration service 210 receives a user selection of one or more templates, e.g., a composite template and a modular template. For example, the administrator may select radio buttons corresponding to composite and modular templates, as illustrated in FIG. 4E. At step 512, configuration service 210 adds, modifies, and/or removes desired configurations for the desired state document automatically and/or based on user selection. Step 512 is explained in detail below in conjunction with FIG. 6.

At step 514, configuration service 210 creates a desired state document that includes desired configurations from the user-selected templates. Configuration service 210 includes any desired configurations that were added or modified at step 512 and excludes any desired configurations that were removed at step 512. At step 516, configuration service 210 receives a user selection of an SDDC(s) or of a cluster(s) to assign the desired state document to. For example, the administrator may select radio buttons corresponding to one or more SDDCs or clusters, as illustrated in FIG. 4F.

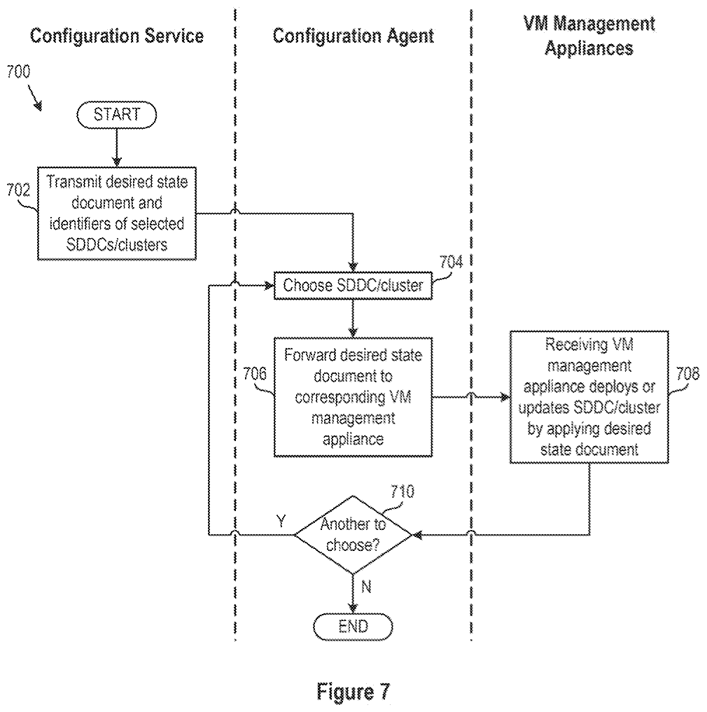

At step 518, configuration service 210 transmits an instruction to configuration agent 270 to deploy or update the selected SDDCs or clusters. Such deployment or updating result in the selected SDDCs or clusters having actual configurations matching the desired configurations of the desired state document. Step 518 is explained in detail below in conjunction with FIG. 7. After step 518, method 500 ends.

FIG. 6 is a flow diagram of a method 600 performed by configuration service 210 to add, modify, and remove desired configurations for a desired state document, according to an embodiment. At step 602, configuration service 210 receives a user selection to add, modify, and/or remove desired configurations for the desired state document. Desired configurations to modify or remove are desired configurations from selected templates for the desired state document. At step 604, configuration service 210 adds, modifies, and/or removes desired configurations according to the user's selections.

At step 606, configuration service 210 acquires actual configurations of an SDDC(s) or a cluster(s) to which the desired state document is to be applied. At step 608, configuration service 210 identifies actual configurations that do not have corresponding desired configurations in the templates selected for the desired state document. At step 610, configuration service 210 adds the identified actual configurations to the desired state document as added desired configurations.

At step 612, configuration service 210 identifies desired configurations that violate predetermined rules for configurating the selected SDDC(s) or cluster(s). For example, one of the desired configured configurations may be to update an “SSH enabled” configuration, which should always store a Boolean value, and the desired configuration may specify a different type of value. As another example, one of the desired configurations may have an expected range such as 0 to 1024, and the desired configuration may specify a value outside the expected range. At step 614, configuration service 210 removes any violating desired configurations from the desired state document and displays error messages accordingly. After step 614, method 600 ends.

FIG. 7 is a flow diagram of a method 700 performed by configuration service 210, configuration agent 270, and a plurality of VM management appliances to apply desired configurations from a desired state document, according to an embodiment. Method 700 is discussed with respect to customer environment 110 and VM management appliances but may be performed with respect to any customer environment and any management appliances. At step 702, configuration service 210 transmits a desired state document to configuration agent 270 along with identifiers of any user-selected SDDCs or clusters to apply the desired state document to. At step 704, configuration agent 270 chooses one of the SDDCs or clusters.

At step 706, configuration agent 270 forwards the desired state document to a corresponding VM management appliance that manages hosts of the chosen SDDC or cluster. At step 708, the receiving VM management appliance deploys (or updates) the SDDC or cluster by applying the desired state document. For example, in the case of VM management appliance 260, plugin orchestrator 320 provides respective desired configurations to plugins 330-336 to be applied to services 340-346 so that actual configurations thereof match corresponding desired configurations from the desired state document. At step 710, if there is another SDDC or cluster to apply the desired state document to, method 700 returns to step 704, and configuration agent 270 chooses another SDDC or cluster. Otherwise, if the desired state document has been applied to each user-selected SDDC or cluster, method 700 ends.

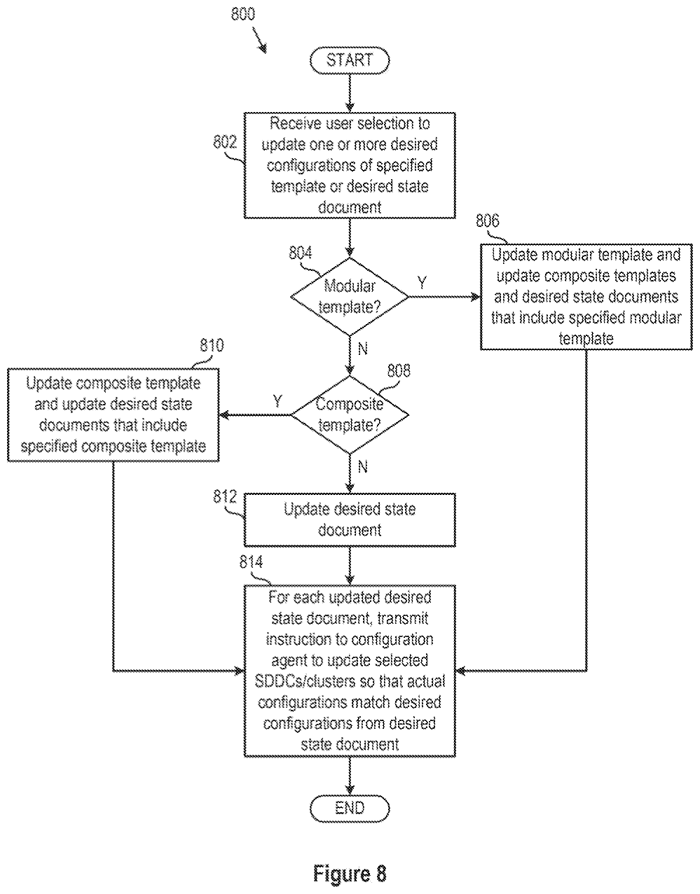

FIG. 8 is a flow diagram of a method 800 performed by configuration service 210 to update a desired state document for retransmitting to one or more SDDCs or clusters, according to an embodiment. Method 800 is discussed with respect to customer environment 110 but may be performed with respect to any customer environment. FIG. 800 is performed after configuration service 210 has already transmitted a previous version of the desired state document to configuration agent 270 and after the previous desired state document has been applied to a selected SDDC(s) or cluster(s). Method 800 is performed periodically, e.g., as administrators of the organization update desired configurations.

At step 802, configuration service 210 receives a user selection to update one or more desired configurations of a specified template or of a specified desired state document. At step 804, if the user is updating a modular template, method 800 moves to step 806. At step 806, configuration service 210 updates the specified modular template according to the user selection by adding desired configurations thereto, modifying desired configurations thereof, and/or removing desired configurations therefrom. Configuration service 210 also accordingly updates composite templates and desired state documents that include the specified modular template.

Returning to step 804, if the user is not updating a modular template, method 800 moves to step 808. At step 808, if the user is updating a composite template, method 800 moves to step 810. At step 810, configuration service 210 updates the specified composite template according to the user selection by adding desired configurations thereto, modifying desired configurations thereof, and/or removing desired configurations therefrom. Configuration service 210 also accordingly updates desired state documents that include the specified composite template.

Returning to step 808, if the user is not updating a composite template, method 800 moves to step 812. At step 812, configuration service 210 updates a specified desired state document according to the user selection by adding desired configurations thereto, modifying desired configurations thereof, and/or removing desired configurations therefrom. At step 814, for each desired state document updated at step 806, 810, or 812, configuration service 210 transmits an instruction to configuration agent 270 to deploy or update selected SDDCs or clusters. Such deployment or updating are to result in the selected SDDCs or clusters having actual configurations matching the desired configurations of the updated desired state document(s), as explained in detail above in conjunction with FIG. 7. After step 814, method 800 ends.

It should be noted that embodiments herein are discussed herein with respect to an administrator that accesses UIs of cloud platform 102 to create desired state documents from modular and composite templates. However, other embodiments are envisioned as well. For example, an administrator that is more comfortable with a command-line interface (CLI) may instead create module templates, composite templates, and desired state documents via a CLI in customer environment 110. In such a case, the desired state documents are stored locally in customer environment 110, and the administrator assigns the desired state documents through command lines to SDDCs and clusters via the CLI.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer-readable media. The term computer-readable medium refers to any data storage device that can store data that can thereafter be input into a computer system. Computer-readable media may be based on any existing or subsequently developed technology that embodies computer programs in a manner that enables a computer to read the programs. Examples of computer-readable media are magnetic drives, SSDs, network-attached storage (NAS) systems, read-only memory (ROM), RAM, compact disks (CDs), digital versatile disks (DVDs), magnetic tapes, and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host, console, or guest operating system (OS) that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A method of managing desired states of software-defined data centers (SDDCs), the method comprising:
in response to a user selection of a first modular template that includes a first set of desired configurations and a user selection of a second modular template that includes a second set of desired configurations, creating a composite template that includes desired configurations from the first and second modular templates; and
in response to a user selection to assign the composite template to an SDDC, creating a desired state document that includes desired configurations from the composite template and then transmitting an instruction to update actual configurations of the SDDC to match corresponding desired configurations from the desired state document.

2. The method of claim 1, wherein the first set of desired configurations includes storage configurations, and the second set of desired configurations includes network configurations.

3. The method of claim 1, wherein in response to the instruction to update actual configurations of the SDDC, management software at the SDDC updates actual configurations of the SDDC to match corresponding desired configurations from the desired state document.

4. The method of claim 1, further comprising:
after transmitting the instruction to update actual configurations of the SDDC, receiving a user selection to modify desired configurations of the first modular template; and
in response to the user selection to modify desired configurations of the first modular template, updating the first modular template, the composite template, and the desired state document and then transmitting an instruction to update actual configurations of the SDDC to match corresponding desired configurations from the updated desired state document.

5. The method of claim 1, further comprising:
before creating the desired state document, receiving a user selection to modify desired configurations for the desired state document that are from the composite template; and
in response to the user selection to modify the desired configurations, adding modified desired configurations to the desired state document.

6. The method of claim 1, further comprising:
before creating the desired state document, acquiring a plurality of actual configurations of the SDDC;
identifying an actual configuration of the plurality of actual configurations that does not have a corresponding desired configuration in the composite template; and
in response to identifying the actual configuration, adding the actual configuration to the desired state document as an added desired configuration.

7. The method of claim 1, further comprising:
identifying a desired configuration of the composite template that violates a predetermined rule for configuring the SDDC; and
in response to identifying the violation of the predetermined rule, excluding the desired configuration from the desired state document.

8. The method of claim 1, further comprising:
receiving user selections to assign to the SDDC, the composite template and a third modular template that includes a third set of desired configurations; and
in response to the user selections to assign the composite template and the third modular template, adding desired configurations from the composite template and the third modular template to the desired state document.

9. A non-transitory computer-readable medium comprising instructions that are executable in a computer system, wherein the instructions when executed cause the computer system to carry out a method of managing desired states of software-defined data centers (SDDCs), the method comprising:
in response to a user selection of a first modular template that includes a first set of desired configurations and a user selection of a second modular template that includes a second set of desired configurations, creating a composite template that includes desired configurations from the first and second modular templates; and
in response to a user selection to assign the composite template to an SDDC, creating a desired state document that includes desired configurations from the composite template and then transmitting an instruction to update actual configurations of the SDDC to match corresponding desired configurations from the desired state document.

10. The non-transitory computer-readable medium of claim 9, wherein the first set of desired configurations includes storage configurations, and the second set of desired configurations includes network configurations.

11. The non-transitory computer-readable medium of claim 9, wherein in response to the instruction to update actual configurations of the SDDC, management software at the SDDC updates actual configurations of the SDDC to match corresponding desired configurations from the desired state document.

12. The non-transitory computer-readable medium of claim 9, wherein the method further comprises:
after transmitting the instruction to update actual configurations of the SDDC, receiving a user selection to modify desired configurations of the first modular template; and
in response to the user selection to modify desired configurations of the first modular template, updating the first modular template, the composite template, and the desired state document and then transmitting an instruction to update actual configurations of the SDDC to match corresponding desired configurations from the updated desired state document.

13. The non-transitory computer-readable medium of claim 9, wherein the method further comprises:
before creating the desired state document, receiving a user selection to modify desired configurations for the desired state document that are from the composite template; and
in response to the user selection to modify the desired configurations, adding modified desired configurations to the desired state document.

14. The non-transitory computer-readable medium of claim 9, wherein the method further comprises:
before creating the desired state document, acquiring a plurality of actual configurations of the SDDC;
identifying an actual configuration of the plurality of actual configurations that does not have a corresponding desired configuration in the composite template; and
in response to identifying the actual configuration, adding the actual configuration to the desired state document as an added desired configuration.

15. The non-transitory computer-readable medium of claim 9, wherein the method further comprises:
identifying a desired configuration of the composite template that violates a predetermined rule for configuring the SDDC; and
in response to identifying the violation of the predetermined rule, excluding the desired configuration from the desired state document.

16. The non-transitory computer-readable medium of claim 9, wherein the method further comprises:
receiving user selections to assign to the SDDC, the composite template and a third modular template that includes a third set of desired configurations; and
in response to the user selections to assign the composite template and the third modular template, adding desired configurations from the composite template and the third modular template to the desired state document.

17. A host computer including a configuration service configured to execute on a processor of a hardware platform of the host computer to manage desired states of software-defined data centers (SDDCs) by performing the following steps:
in response to a user selection of a first modular template that includes a first set of desired configurations and a user selection of a second modular template that includes a second set of desired configurations, creating a composite template that includes desired configurations from the first and second modular templates; and
in response to a user selection to assign the composite template to an SDDC, creating a desired state document that includes desired configurations from the composite template and then transmitting an instruction to update actual configurations of the SDDC to match corresponding desired configurations from the desired state document.

18. The host computer of claim 17, wherein the first set of desired configurations includes storage configurations, and the second set of desired configurations includes network configurations.

19. The host computer of claim 17, wherein in response to the instruction to update actual configurations of the SDDC, management software at the SDDC updates actual configurations of the SDDC to match corresponding desired configurations from the desired state document.

20. The host computer of claim 17, wherein the configuration service is further configured to perform the following steps:
after transmitting the instruction to update actual configurations of the SDDC, receiving a user selection to modify desired configurations of the first modular template; and
in response to the user selection to modify desired configurations of the first modular template, updating the first modular template, the composite template, and the desired state document and then transmitting an instruction to update actual configurations of the SDDC to match corresponding desired configurations from the updated desired state document.

21. The host computer of claim 17, wherein the configuration service is further configured to perform the following steps:
before creating the desired state document, receiving a user selection to modify desired configurations for the desired state document that are from the composite template; and
in response to the user selection to modify the desired configurations, adding modified desired configurations to the desired state document.

22. The host computer of claim 17, wherein the configuration service is further configured to perform the following steps:
before creating the desired state document, acquiring a plurality of actual configurations of the SDDC;
identifying an actual configuration of the plurality of actual configurations that does not have a corresponding desired configuration in the composite template; and
in response to identifying the actual configuration, adding the actual configuration to the desired state document as an added desired configuration.

23. The host computer of claim 17, wherein the configuration service is further configured to perform the following steps:
identifying a desired configuration of the composite template that violates a predetermined rule for configuring the SDDC; and
in response to identifying the violation of the predetermined rule, excluding the desired configuration from the desired state document.

24. The host computer of claim 17, wherein the configuration service is further configured to perform the following steps:
receiving user selections to assign to the SDDC, the composite template and a third modular template that includes a third set of desired configurations; and
in response to the user selections to assign the composite template and the third modular template, adding desired configurations from the composite template and the third modular template to the desired state document.
